(19) United States
(12) Patent Application Publication
(10) Pub. No.: US 2016/0159182 A1
(43) Pub. Date: Jun. 9, 2016

(54) MULTI-PIECE BAR PIN FOR ELASTOMERIC BUSHING ASSEMBLY

(71) Applicant: The Pullman Company, Milan, OH (US)

(72) Inventors: Joseph F. CERRI, III, Norwalk, OH (US); Zoren E. GASPAR, Huron, OH (US)

(21) Appl. No.: 14/559,129

(22) Filed: Dec. 3, 2014

(51) Int. Cl. B60G 11/12; F16C 17/02; F16C 11/04

(52) U.S. Cl. CPC B60G 11/12; F16C 11/04; F16C 17/02; F16C 2326/20; B60G 2204/121

(57) ABSTRACT

A bar pin for an elastomeric bushing assembly couples components of a vehicle. The bar pin may include a body member and a beam member. The body member defines a hollow center. The beam member includes a plurality of plates arranged in a stacked configuration. The plurality of plates forms a tab portion and a body portion of the beam member. The body portion is housed in the hollow center of the body member and the tab portion extends outward beyond the body member.

### FIELD

The present disclosure relates to a bar pin. More particularly, the present disclosure relates to a bar pin used with an elastomeric bushing assembly for coupling components of a vehicle to each other.

### BACKGROUND

This section provides background information related to the present disclosure which is not necessarily prior art.

A bar pin, which may also be referred to as a straddle pin, may be used with an elastomeric bushing to couple components of a vehicle to one another. For instance, applications for a bar pin include, but are not limited to, torsion bars, linear torque rods, V-shaped torque rods, leaf springs, independent suspension control arms and other suspension control devices. These and other applications are used on a wide variety of vehicles such as trucks, buses, off-highway vehicles, rail cars and other transportation applications.

The bar pin may be made of a solid piece of metal such as steel which may be forged or machined from solid stock or near net shaped pieces. The bar pin may include a center body and tabs that extend from the center body. The tabs may have a flat surface and a smaller cross-section than the center body. The center body may have a cylindrical-like shape and is generally configured to fill a gap between the elastomeric bushing and the tabs. The tabs are utilized for connecting components of the vehicle, while the center body interfaces with the elastomeric bushing.

The bar pin undergoes various stresses and/or loads which, over time, may cause wear and fatigue. For instance, the tabs of the bar pin may experience higher stress than the center body due to the change in cross sectional area between the center body and the tabs. By having the bar pin formed out of a single piece, points of stress concentration may be formed between the tabs and the center body which may cause premature failure.

Furthermore, during the manufacturing process of the bar pin, material is removed from a large piece of solid material in order to form the solid single piece bar pin having different shaped and sized portions, and thereby resulting in a labor intensive manufacturing process and wasted material.

### SUMMARY

This section provides a general summary of the disclosure, and is not a comprehensive disclosure of its full scope or all of its features. The present disclosure provides for a bar pin for an elastomeric bushing assembly. The bar pin couples components of a vehicle.

The bar pin may include a body member and a beam member. The body member may define a hollow center. The beam member includes a plurality of plates arranged in a stacked configuration. The plurality of plates may form a tab portion and a body portion of the beam member. The body portion is housed in the hollow center of the body member and the tab portion extends outward beyond the body member.

In an aspect of the present disclosure, the body member may include two shell sections, and each of the shell sections define a cavity that forms the hollow center of the body member when the shell sections are joined. One of the two shells is arranged along a first side of the plurality of plates and the other shell is arranged along a second side of the plurality of plates opposite to the first side.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a leaf spring incorporating a bar pin of the present disclosure;

FIG. 2A is a perspective view of an elastomeric bushing assembly that includes the bar pin of the present disclosure;

FIG. 2B is a perspective view of the bar pin of the present disclosure;

FIG. 3 is a perspective view of the bar pin including a beam member and a body member in a first embodiment;

FIG. 4 is an end view of the bar pin of FIG. 3;

FIG. 5 is a cross-sectional view of the bar pin along line 5-5 of FIG. 4;

FIG. 6 is an exploded view of the bar pin;

FIG. 7 is a cross-sectional view of a bar pin in a second embodiment;

FIG. 8 is a perspective view of plates of a beam member of the bar pin of FIG. 7;

FIGS. 9A and 9B are perspective views of a shell of a body member of the bar pin of FIG. 7;

FIG. 10 is a perspective view of a bar in a third embodiment; and

FIG. 11 is a perspective view of a shell of a body member of FIG. 10.

Corresponding reference numerals indicate corresponding parts throughout the several views of the drawings.

### DETAILED DESCRIPTION

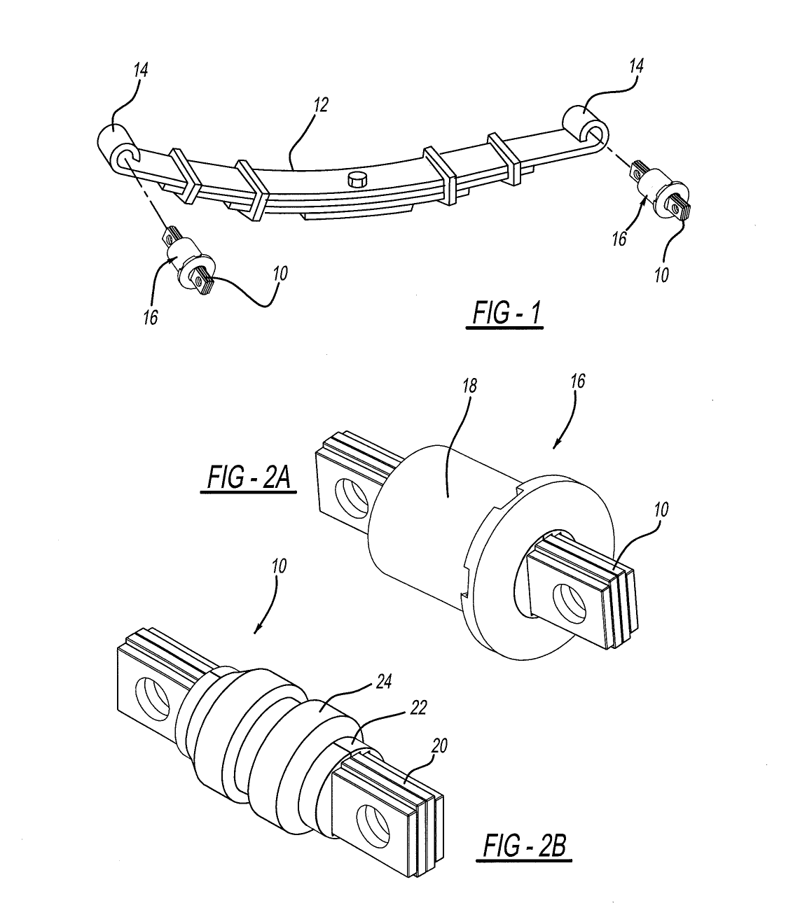

The present disclosure will now be described more fully with reference to the accompanying drawings. A bar pin is commonly used with an elastomeric bushing assembly to couple two components of a vehicle. FIG. 1 illustrates an example application of a bar pin 10 of the present disclosure. In the example illustrated, a leaf spring 12 of a vehicle has two mounts 14 that receive bar pin 10 which is disposed in an elastomeric bushing assembly 16. That is, each of the mounts 14 receive elastomeric bushing assembly 16 which is pressed fit into mounts 14. Bar pin 10 fastens leaf spring 12 to, for example, a bracket of the vehicle.

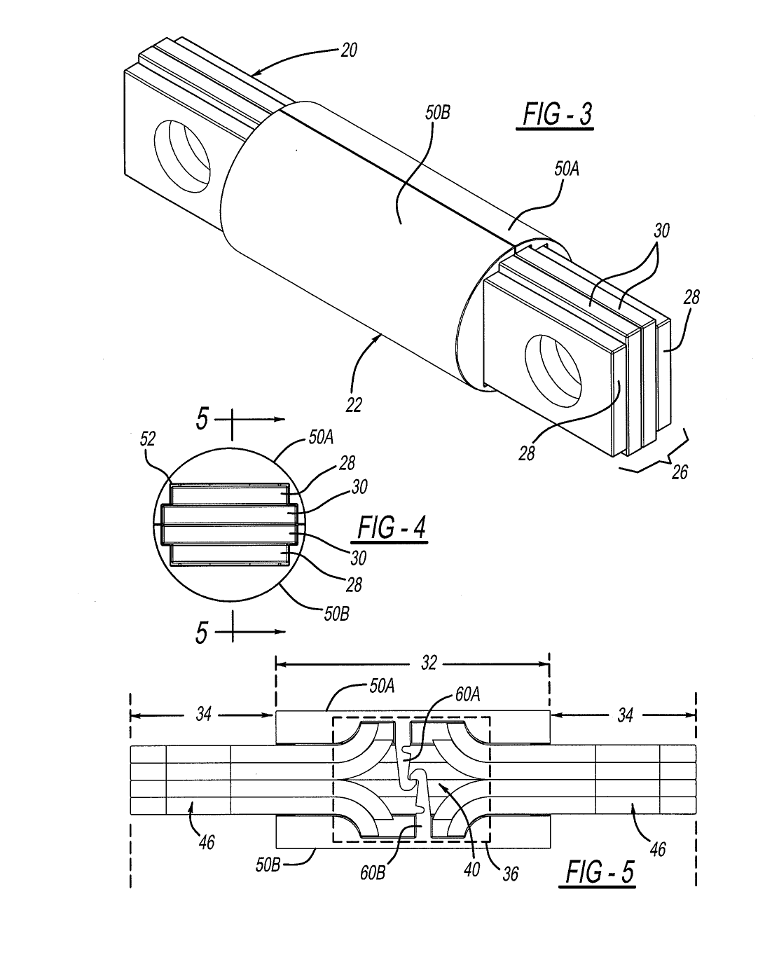

Referring to FIGS. 2A-4, elastomeric bushing assembly 16 includes bar pin 10 and an outer sleeve 18. Bar pin 10 is disposed in outer sleeve 18. Outer sleeve 18 may have a cylinder like shape and may be made of steel. Bar pin 10 includes a beam member 20, a body member 22, and an elastomer member 24. Beam member 20 extends past ends of mount 14 to couple to the vehicle components. Beam member 20 connects to the vehicle components and body member 22 occupies the space between beam member 20 and elastomer member 24. Elastomer member 24 is molded around an outer surface of the body member 22. When arranged in mounts 14, elastomeric bushing assembly 16 provides spring rate, dampens vibrational energy, and provides suspension articulation capability.

Beam member 20 includes a plurality of plates 26 that are arranged in a stacked configuration. Plates 26 may have varying width such that when stacked together, the plates 26 form a rounded cross-section of beam member 20. More particularly, plates 26 include end plates 28 and intermediate plates 30 which are disposed between end plates 28. A width of end plates 28 is shorter than a width of intermediate plates 30. The width of plates 26 is measured along an x-axis. Accordingly, by arranging plates 26 such that the width of the plates 26 decreases from a center plate to end plates, beam member 20 may have a rounded cross-section with a step-like contour or profile (FIG. 4). While the example embodiment illustrates two different styles of plates 26 (i.e., plates 28 and 30), beam member 20 may include more than two different styles of plates for forming the rounded cross-section of beam member 20. Plates 26 are made of a heavy metal such as steel and may be a stamped component.

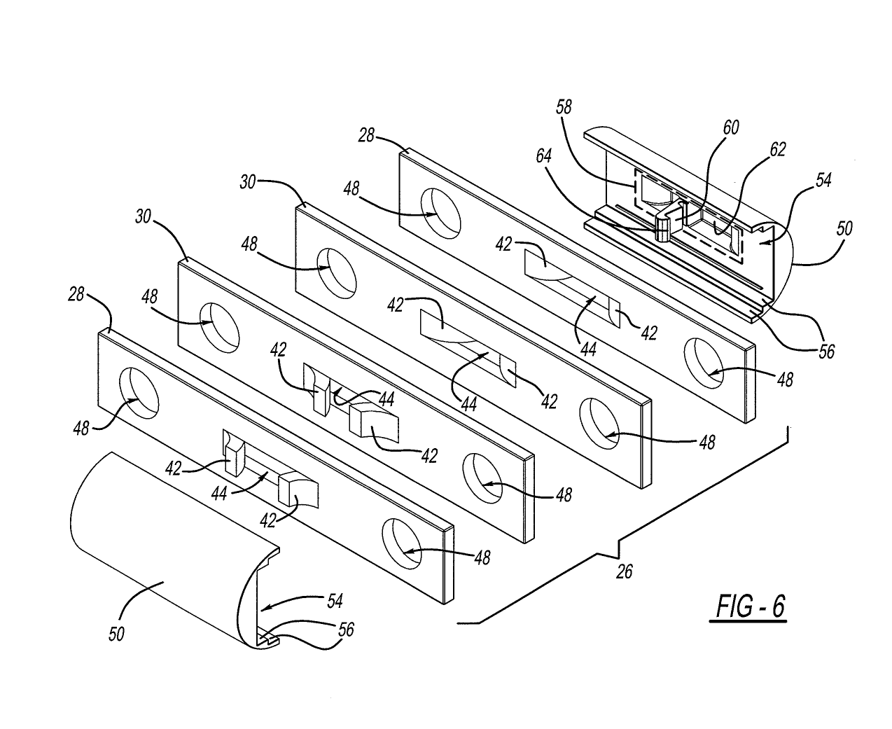

With additional reference to FIGS. 5-6, beam member 20 includes a body portion 32 disposed between two tab portions 34. Body portion 32 is disposed in body member 22 and tab portions 34 extend from body member 22. When disposed in outer sleeve 18, tab portions 34 extend beyond the ends of outer sleeve 18 (FIG. 2A). Body portion 32 includes a beam retention feature 36 for interfacing with body member 22. In the example embodiment, beam retention feature 36 includes a protruding strip section 38 and an opening 40 defined by the protruding strip section 38.

More particularly, each of the plates 26 include two protruding strips 42 and defines a gap 44 between protruding strips 42. Plates 26 are arranged such that protruding strips 42 of one end plate 28 and one intermediate plate 30 project upward (i.e., a first direction) and protruding strips 42 of the other end plate 28 and the other intermediate plate 30 project downward (i.e., second direction opposite of first direction). In the stacked configuration, opening 40 is defined by gaps 44 of each of the plates 26.

Each of the tab portions 34 defines a bore 46 which receives a fastener, such as a bolt, a screw, and/or a washer, for fastening bar pin 10 to a vehicle component such as a bracket. That is, each of the plates 26 define a hole 48 which forms bore 46 when plates 26 are stacked.

Body member 22 includes two shells 50 (i.e., 50A and 50B) which may form a cylindrical-shaped casing when joined together. Body member 22 may be made of a light weight material such as plastic or a light weight metal like aluminum. In the following description herein, shells 50A and 50B are substantially the same and may collectively be referred to as shells 50, and the description of shells 50 is applicable to both shell 50A and 50B. Features and/or components designated with “A” correspond with shell 50A and components designated with “B” correspond with shell 50B.

Body member 22 defines a hollow center 52 for housing beam member 20. More particularly, each of the shells 50 defines a cavity 54 which forms the hollow center 52 when joined together. Shells 50 include a series of steps 56 that align with the contour of plates 26 such that body member 22 retains plates 26 in a stacked configuration and prevents plates 26 from moving along the x-axis.

Shells 50 includes a core retention feature 58 which interfaces with beam retention feature 36. In the example embodiment, core retention feature 58 includes a peg 60 and defines a slot 62. The peg 60 has a hook-shaped end 64 and extends from an inner surface of the slot 62.

When shells 50A and 50B are disposed around plates 26, core retention features 58A and 58B extend through beam retention feature 36 at opposite sides of beam member 20 and couple to each other. For example, peg 60A and 60B extend through opening 40 between protruding strip section 38. Hook-shaped end 64A of core retention feature 58A couples with hook-shaped end 64B of core retention feature 58B. Pegs 60A and 60B couple to each other to prevent significant movement of body member 22 and beam member 20 along the x-axis prior to the molding of the elastomer member 24. Protruding strips 42 of end plates 28 extend into slots 62A and 62B such that the protruding strips 42 abuts with slots 62A and 62B to prevent significant movement of body member 22 and beam member 20 along a y-axis prior to the molding of the elastomer member 24.

Bar pin 10 includes beam member 20 and body member 22 which encapsulates body portion 34 of beam member 20. Beam member 20 includes an attachment feature such as bores 46 for coupling bar pin 10 to components of the vehicle via a fastener. Body member 22 which has the elastomer member 24 disposed thereon interfaces with the bushing disposed on the vehicle. Body member 22 fills a space between beam member 20 and elastomer member 26 of elastomeric bushing assembly 16.

Beam member 20 is subjected to higher mechanical stress than body member 22, and may therefore be made of a stronger material than body member 22. More particularly, prior to assembly, beam member 20 is a separate component and may therefore be made of a different material than body member 22, which may reduce the cost of bar pin 10 and reduce the amount of material wasted during manufacturing since the bar pin is not formed from a single piece of material.

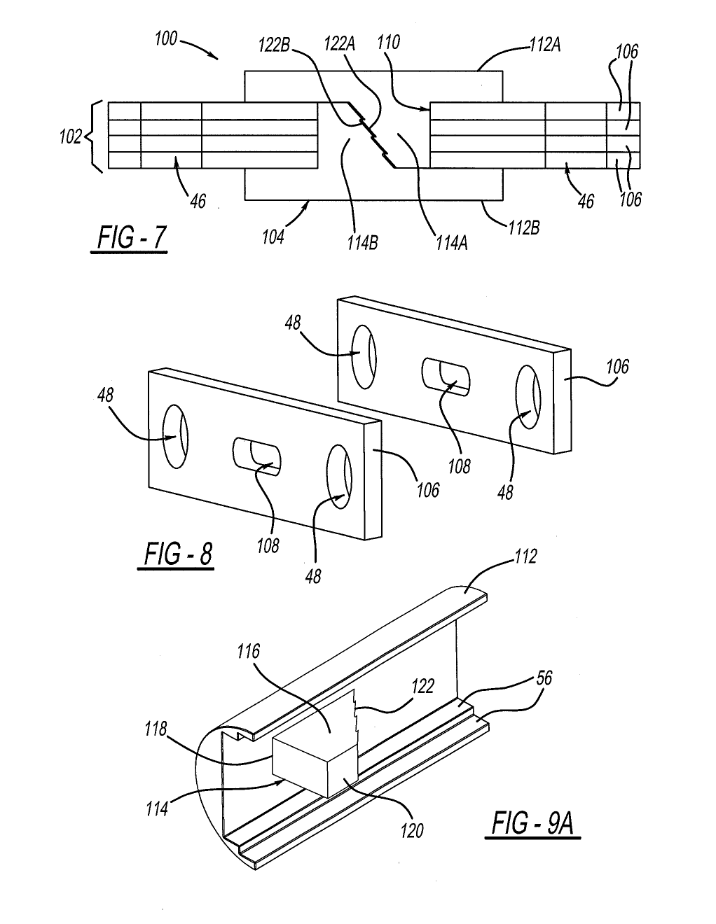

In the example embodiment, beam member 20 includes beam retention feature 36 and body member 22 includes core retention feature 58 for securing beam member 20 and body member 22 to each other. Beam member 20 and body member 22 may have other suitable retention features and are not limited to the one illustrated in FIGS. 5-6. For example, FIGS. 7-9B illustrate a second example of a retention feature for coupling beam member and a body member of a bar pin.

More particularly, FIG. 7 illustrates a bar pin 100 that includes a beam member 102 and a body member 104. Like beam member 20, beam member 102 includes a plurality of plates 106 that are arranged in a stacked configuration. Each of the plates 106 defines hole 48 and also defines a gap 108 (FIG. 8). In the stacked configuration, plates 106 define bore 46 via holes 48 and an opening 110 via gaps 108. Unlike plates 26, plates 106 do not include protruding strips.

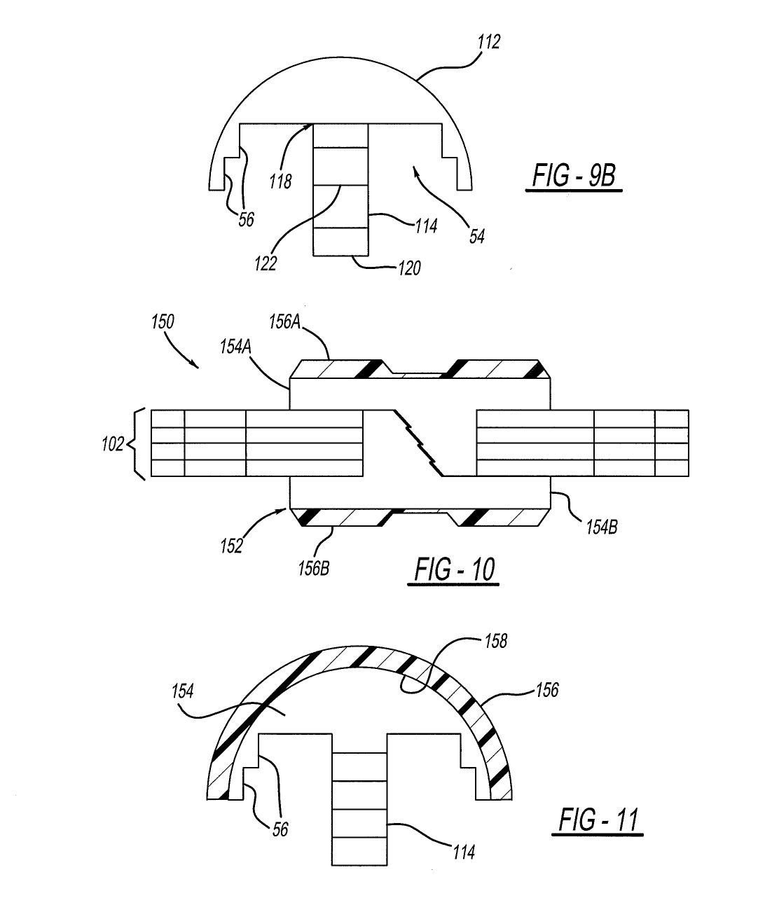

Body member 104 includes half shells 112. Shells 112 include a peg 114 that extends from an inner surface of shells 112 (FIGS. 9A and 9B). Pegs 114 have a fin like shape. That is, pegs 114 has a tapered body 116 which starts from a base portion 118 at the inner surface and extends to a top portion 120. Tapered body 116 may include a series of ribs 122 along a surface of the tapered body 116. Similar to shells 50, shells 112 also include steps 56 for aligning and retaining plates 106 in a stacked configuration.

Pegs 114 are provided as a core retention feature of body member 104 and opening 110 is provided as a beam retention feature of beam member 102. When shells 112A and 112B are disposed around plates 106, pegs 114A and 114B extend through opening 110 at opposite sides of beam member 102. Ribs 122A and 122B engage with each other to fasten shells 112A and 112B. Pegs 114 may extend fully across opening 110 and to the inner surface of the shells 112. For example, the top portion 120A of peg 114A may abut with an inner surface of shell 112B and the top portion 120B may abut with an inner surface of shell 112A. Alternatively, pegs 114 may extend to other suitable positions within opening 110 such that pegs 114A and 114B are at least adjacent to each other. Pegs 114 and opening 110 align and hold plates 106 and shells 112 with each other.

With body member (22,104) attached to beam member (20,102) via beam member retention feature and core retention feature, the elastomer member 24 is molded onto body member (22,104) and may be portions of beam member (20,102), thereby securing and fixedly attaching body member (22,104) and beam member (20,102) to each other. In addition to or in lieu of elastomer member 24, body member and beam member may be fixedly attached to each other using other suitable methods, such as a chemical adhesive and/or mechanical fastener.

The elastomer member may also be molded onto body member before body member is attached to beam member. For example, FIGS. 10-11 illustrate a bar pin 150 which includes beam member 102 and a body member 152. Body member 152 includes half shells 154 which are similar to half shells 112 and includes pegs 114 as the core retention feature. Body member 152 also includes an elastomer portion 156 which is molded onto an outer surface 158 of shell 154. Body member 152 may then be attached to beam member 102 via the beam retention feature and the core retention feature. Body member 152 and beam member 102 may be fixedly connected via various suitable methods, such as welding or adhesives.

By having the elastomer portion 156 pre-formed on shells 154, the additional step of molding the elastomer after assembling body member and beam member is no longer needed. The elastomer portion may also be applied to body member 22 which has core retention feature 58 and is not limited to body member 152.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, and/or components, but do not preclude the presence or addition of one or more other features, elements, components, and/or groups thereof.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

What is claimed is:

1. A bar pin for coupling components of a vehicle, the bar pin comprising:
a body member defining a hollow center; and
a beam member disposed in the hollow center and the beam member including a plurality of plates arranged in a stacked configuration, wherein the plurality of plates extend outward beyond ends of the body member.

2. The bar pin of claim 1 wherein:
the beam member defines an opening, and
the body member includes a peg that extends from an inner surface of the body member and passes through the opening of the beam member such that the beam member and the body member are aligned via the peg and the opening.

3. The bar pin of claim 1 wherein the body member has a cylindrical like shape.

4. The bar pin of claim 1 wherein the body member is made of a lighter material than the beam member.

5. The bar pin of claim 1 wherein the body member includes two half shells that define the hollow center when joined together.

6. The bar pin of claim 1 further comprising:
an elastomer molding disposed around the body member.

7. The bar pin of claim 1 wherein the plurality of plates includes plates of varying width which are arranged in the stacked configuration such that a plate disposed at a center of the stacked configuration has a greater width than a plate disposed at an end of the stacked configuration.

8. The bar pin of claim 1 wherein each of the plurality of plates defines a hole that form a bore when the plurality of plates are arranged in the stacked configuration.

9. The bar pin of claim 1 wherein an inner surface of the body member has a step shaped profile and the plurality of plates of the beam member are aligned within the step shaped profile of the body member.

10. An elastomeric bushing assembly comprising:
the bar pin of claim 1;
an elastomer member disposed around the body member of the bar pin; and
an outer sleeve, wherein the bar pin with the elastomer member are disposed in the outer sleeve such that the plurality of plates extend outward beyond ends of the outer sleeve.

11. An elastomeric bushing assembly for coupling components of a vehicle, the elastomeric bushing assembly comprising:
a body member including a plurality of shells, wherein each of the plurality of shells defines a cavity which forms a hollow center when the plurality of shells are joined together; and
a beam member including a plurality of plates arranged in a stacked configuration, wherein the plurality of plates form a tab portion and a body portion of the beam member, the body portion is housed in the hollow center of the body member and the tab portion extends outward beyond the body member.

12. The elastomeric bushing assembly of claim 11 wherein:
the beam member includes a beam retention feature at the body portion and a vehicle connection feature at the tab portion, the vehicle connection feature receives a fastener to couple to the components of the vehicle, and
the body member includes a core retention feature which interfaces with the beam retention feature of the beam member to align the beam member and the body member to each other.

13. The elastomeric bushing assembly of claim 12 wherein:
the beam retention feature of the beam member defines an opening and includes a protruding strip section, the protruding strip section extends in a first direction and in a second direction opposite of the first direction,
the core retention feature of the body member includes one or more pegs that extend from an inner surface of the body member and defines one or more slots at the inner surface of the body member, and
the pegs of the core retention feature extend through the opening of the beam retention feature, and the protruding strip section of the beam retention feature interfaces with the one or more slots of the core retention feature.

14. The elastomeric bushing assembly of claim 11 wherein:
the beam member defines an opening at the body portion,
the plurality of shells includes two shells and each of the shells includes a peg that extends from an inner surface of the shell, and
one of the two shells is arranged along a first side of the beam member and the other shell is arranged along a second side of the beam member opposite the first side, and the pegs of the two shells extend through the opening of the body portion from opposite sides of the beam member and meet in the opening.

15. The elastomeric bushing assembly of claim 14 wherein each of the pegs have a hook shaped end that connect to each other.

16. The elastomeric bushing assembly of claim 11 wherein the plurality of shells includes two shells, one of the two shells is arranged along a first side of the plurality of plates and the other shell is arranged along a second side of the plurality of plates opposite to the first side.

17. The elastomeric bushing assembly of claim 11 wherein each of the plurality of shells have an elastomer portion disposed on an outer surface of the shell.

18. The elastomeric bushing assembly of claim 11 wherein each of the plurality of plates define a hole at opposite sides of the plate to form a bore at the tab portions of the beam member when the plurality of plates are arranged in the stacked configuration.

19. The elastomeric bushing assembly of claim 11 further comprising:
an elastomer member disposed around the body member, wherein the body member fills a void between the beam member and the elastomer member.

20. The elastomeric bushing assembly of claim 11 further comprising:
an outer sleeve, wherein the beam member and body member are disposed in the outer sleeve such that the tab portion extends beyond ends of the outer sleeve, and
an elastomer member disposed around the body member, wherein the elastomer member is between the outer sleeve and the body member, and the body member fills a void between the beam member and the elastomer member.

21. An elastomeric bushing assembly for coupling components of a vehicle, the elastomeric bushing assembly comprising:
an outer sleeve; and
a bar pin disposed in the outer sleeve, the bar pin including:
a body member including two shell sections and defining a hollow center, wherein each of the shell sections defines a cavity that form the hollow center of the body member, and
a beam member disposed in the hollow center of the body member, the beam member including a plurality of plates arranged in a stacked configuration, wherein
the plurality of plates includes plates of varying width which are arranged in the stacked configuration such that a plate disposed at a center of the stacked configuration has a greater width than a plate disposed at an end of the stacked configuration,
one of the two shells is arranged along a first side of the plurality of plates and the other shell is arranged along a second side of the plurality of plates opposite to the first side, and
the plurality of plates form a tab portion and a body portion of the beam member, the body portion is housed in the hollow center of the body member and the tab portion extends outward beyond the outer sleeve.

22. The elastomeric bushing assembly of claim 21 further comprising:
an elastomer member disposed around the body member, wherein the body member fills a void between the beam member and the elastomer member.

23. The elastomeric bushing assembly of claim 21 wherein:
the beam member includes a beam retention feature at the body portion and a vehicle connection feature at the tab portion, the vehicle connection feature receives a fastener to couple to the components of the vehicle, and
the body member includes a core retention feature which interfaces with the beam retention feature of the beam member to align the beam member and the body member to each other.
